(19) United States
(12) Patent Application Publication
(10) Pub. No.: US 2009/0220819 A1
(43) Pub. Date: Sep. 3, 2009

(54) BIMETALLIC DOCTOR BLADE WITH WORKING EDGE PRODUCED BY POWDER METALLURGY

(75) Inventors: Gregor Innitzer, Wien (AT); Leander Ahorner, Waidhofen/Ybbs (AT)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(73) Assignee: GREGOR INNITZER ET AL

(21) Appl. No.: 12/159,671

(22) PCT Filed: Dec. 29, 2006
(86) PCT No.: PCT/EP2006/012611

§ 371 Date: Oct. 21, 2008

(30) Foreign Application Priority Data
Dec. 29, 2005 (DE) 10 2005 062 911.3

(51) Int. Cl. B32B 15/18; B23K 31/02; C21D 1/00; B22F 7/04

(52) U.S. Cl. 428/638; 228/176; 148/514

(57) ABSTRACT

A bimetallic doctor blade (1) has a support strip (20) made of conventionally produced steel and a working edge (10) made of a steel produced by a powder metallurgical process. Also disclosed is a method for producing this type of bimetallic doctor blade (1), wherein a flat wire is produced from metal powder by a powder metallurgical process, and the flat wire is then welded to a conventionally produced support strip (20) made of steel in order to form a bimetallic doctor blade with a support strip (20) and a working edge (10).

### 1. TECHNICAL FIELD

The invention relates to a doctor blade which is used with paper manufacturing and paper coating as well in the printing industry.

### 2. PRIOR ART

In general, a doctor blade is about a long strip-shaped tool with a straight edge which to has a high abrasion resistance. In the paper industry, doctor blades are used for various applications and named for this purpose respectively. For stripping a paper web, doctor blades as so called stripping blades or “doctor blades” are used. Thereby, the doctor blades are pressed against the moving paper web, wherein a counter pressure is generated by a counter-roller or another doctor blade at the opposite side of the paper web.

For creping of the paper, doctor blades are used as so called scraper or “creping blades”. Also, here the doctor blades have to have a particular straightness and stability.

During coating of the paper with a coating slip, doctor blades are use as so called coating blades, doctor bars or “coater blades”. Thereby, the doctor blade has to be particularly straight if a uniform high quality coating of the paper has to be achieved. The common specification said that the working edge of the doctor blade must not differ more as 0.3 mm per 3000 mm length of the doctor blade from the absolute straightness.

In addition, doctor blades are also used in the print industry as stripping blade or stripping scraper.

Doctor blades are highly stressed and at its edges wears, for example by scraping pigments in the material which is applied on the paper surface or by the basis paper itself. According to this, it is desirable, that the doctor blades have an edge with a high abrasion resistance and thus a high durability.

In the following, the term “doctor blade” is used for any kind of strip-shaped tool which has to satisfy high requirements with respect to straightness, edge wear resistance and straightness for the respective application.

However, doctor blades composed of carbon steel and such of martinsitic stainless steel satisfy these high requirements only in a limited extend. The duration of these doctor blades is very limited what results in undesired tool changes. Thus, it is usual practice to exchange the doctor blade already after a few operation hours, for example in a paper device. This is in particular disadvantageously due to the production looses during exchanging the blades.

Therefore, different tests have been achieved to improve the stability of a doctor blade.

A known method for increasing the durability of a doctor blade is to coat the working edges with a ceramic layer; thereby the effect durability of a doctor blade is clearly increased. The use of ceramic-layered blades is not economically possible in every application field due to its high price.

Furthermore, in WO 2002/035002 A1 it is proposed to use a bimetallic doctor blade. In this case the support strip of the doctor blade consists of a viscous plastic steel on which an abrasion proved strip of HSS-material (HSS=high performance high speed steel) as edge material is welded in order to increase the stability of a doctor blade.

In order to increase the hardens and thus the durability, HSS-material consists usually carbide building components, for example molybdenum (Mo), vanadium (Va) chromium (Cr) or tongue stick (W) and carbon (C) in according proportions. Generally, it is true that the hardness of the material increases with increasing carbide proportions. However, this carbide building components tents to build large carbide crystals in the steel during a conventional producing method by the solidifying of the melting.

However, such large carbide crystals are undesired in doctor blades, since the material (the matrix) around the hard carbide crystals draws stronger as the carbide crystals itself during using of a doctor blade.

Thus, after a certain lifetime, the carbide crystals protrude out from the surrounding steel matrix of the working edge of the doctor blades. This can result in undesired grooves on the paper surface or strips in the coating of the paper. Furthermore, the counter-rollers are usually coated with a plastic material which can be damaged by the afore-mentioned carbide crystals.

From U.S. Pat. No. 3,766,808 A a bimetal-band saw is known, wherein its teeth tips are powder metallurgic made. Thereby, a layer of teeth tips is powder metallurgic produced directly on a support strip.

EP 0 163 914 A1 describes a method for producing a saw blade in which sintered coating blades are welded on a support blade by means of an electron or laser beam.

Therefore, it is an object of the present invention to provide a doctor blade which has an improved durability and which can still be produced inexpensively. Furthermore, it is an object of the invention to provide an improved method for manufacturing a doctor blade.

### 3. SUMMARY OF THE INVENTION

The above-mentioned object are solved by a doctor blade according to patent claim 1 as well by a method for manufacturing a doctor blade according patent claim 12.

In particular, the above-mentioned objects are solved by a doctor blade having a support strip made of conventionally produced steel and a working edge made of a steel, wherein the working edge is produced by a powder metallurgical process and the working edge consists of a wire which is produced by a powder metallurgical process and which is welded on a support strip. It is preferred that the wire is a flat wire with a quadratic or rectangular cross section before welding. The working edge is in particular advantageously thereby produced that a wire, in particular a flat wire, is welded on the support strip.

By means of a powder metallurgical producing method a working edge can be produced with a steel which has in particular a high carbide proportion but which has still only a great number of homogeneously distributed and globular carbide crystals so that the thereof produced doctor blades are uniformly worked at the working edge and no groove forming in the paper or strips in the coating of the paper occurs. By means of the powder metallurgical producing method large carbide crystals and the various involved disadvantageous are avoided. Therefore, the structure is in total very much fine-grained as in conventionally melded steels even with equal composition.

In addition, the powder metallurgical produced working edge according to the invention has a high hardness and thus a high wear resistance depending on the steel composition. Since only the working edge is made of a powder metallurgical producing method, it results that in comparison to a possible doctor blade made of powder metallurgical produced tool material with same standing time a comparatively inexpensive doctor blade.

Also, a powder metallurgical produced working edge has advantages with reference to the hardenability. With equal austenite temperature and time a higher hardness is achieved as with conventionally produced steels.

Preferably, the working edge is made of steel with a steel composition, comprising in percent per weight

| | Percent per |
|---|---|
| Component | weight |
| C | 0.5-2.0% |
| Cr | 2-8% |
| Mo | 1-10% |
| V | 1-6% |

and the remain is basically iron (Fe) and impurities in normal proportions.

The claimed steel composition is in particular proper for the powder metallurgical producing of flat wires which are used as starting material for the working edge. Furthermore, such like steel forms the above-mentioned small, homogeneously distributed and globular carbide crystals and can be well hardened.

The support strip made of conventional produced steel can be easily adapted to the respective application with respect to its solidity and elasticity. For the support strip a tool steel or a spring steel is preferred. Therewith, combinations of a relative elastic support strip and a very hard and abrasion resistant working edge the material of which as eventually improper as support strip material, are possible.

In a further embodiment, the steel of the working edge further comprises 1 to 12 percent by weight Co. An additive of cobalt (Co) to the steel increases in particular the thermal stability of the working edge.

The steel of the working edge preferably has the following steel composition:

| | Percent per |
|---|---|
| Component | weight |
| C | 0.9-1.7% |
| Cr | 3.8-5.0% |
| Mo | 2-6% |
| V | 2.5-6.0% |
| Co | 4.5-9.0% |

and the remain is basically iron (Fe) and impurities in normal proportions.

A powder metallurgical made steel of this composition is in particular proper for producing a flat wire likewise it is used as starting material for the working edge. Also, this steel can be well welded on the support strip. Such steel has in particular extra fine and homogeneously distributed, globular, i.e. basically round carbides which also after a considerable using of the doctor blade, do not cause grooves. Thereby, the standing time of the doctor blade is considerable increased.

In a preferred embodiment the working edge has carbides and basically all carbides of the working edge have diameters which are smaller as 4 μm more preferably smaller as 3 μm. Therewith, it is particularly avoided that large carbides protrude from the matrix and cause grooves on the paper surface.

The term “basically all carbides” reads in the context that on a surface of 1000 μm m² of a random metal graphic cross polished section of a working edge at the most three carbides with a diameter above 4 μm, preferably at the most two carbides with a diameter above 4 μm and more preferably only one carbide with a diameter above 4 μm is detected. It is most preferred that no carbide with a diameter about 4 μm exists.

In a further preferred embodiment the working edge has a hardness of 53 to 68 HRc. Generally, a high hardness provides a high standing time.

In particular, the wire is welded on the support strip by means of a laser beam. This welding method has the advantage that with this only one local limited heat input at the welded joint occurs so that a growing of the carbides is avoided. With respect to for example the electron beam welding, it has the advantage that the laser welding has not to be carried out in vacuum and that a degassing of the edge material is avoided which would cause undesirable micro pores on the surface of the working edge and at the joining zone between working edge and support material.

Preferably, the wire is made of a block which is made by means of a heat isostatic pressing out of a metallic powder. The metallic powder is pressed into an almost pore-free block which can be easily processed by means of a heat isostatic pressing.

The support strip has in a further preferred embodiment the following steel composition:

| | Percent per |
|---|---|
| Component | weight |
| C | 0.15-0.60% |
| Si | <1.5% |
| Mn | <1.5% |
| Cr | 0.5-6.5% |
| Mo | 0.5-3% |
| W | <4% |
| V | 0.03-0.75% |
| Nb | <0.15% |
| Ni | <2.0% |
| Al | <0.15% |
| Co | <4.2% |
| Zr u/o Ti u/o Ta | <0.01% |
| B | <0.001% |

wherein Mo+W/2=0.5-3% and V+Nb=0.03-0.75% respectively, the remain is basically iron (Fe) and impurities, depending on the smelting in normal proportions.

This steel composition is in particular proper for the utilization as support strip for doctor blades which in use are elastically preloaded against moving surfaces due to its mechanical strong properties and elastic values.

In preferred embodiments the bimetallic doctor blade has a broadness of 10 to 250 mm and a thickness of 0.65 to 1.25 mm, in particular
a) a thickness of 0.065 to 0.203 mm for utilisation as doctor blade for pressure applications; or
b) a thickness of 0.25 to 0.64 mm for the utilisation as coater blade for paper production; or
c) a thickness of 1.2 to 1.25 mm for utilisation as creping blade for paper production.

The afore-mentioned objects are as well solved by a method for manufacturing a bimetallic doctor blade comprising the following steps:
a) Producing of a flat wire from a metal powder by means of a powder metallurgical producing method;
b) welding the flat wire on a conventionally produced support strip made of steel in order to build a bimetallic doctor blade with support strip and working edge.

Therewith, the above-mentioned advantageous of the bimetallic doctor blade are achieved as well.

In a first preferred embodiment the flat wire has the following steel composition:

| | Percent per |
|---|---|
| Component | weight |
| C | 0.5-2.0% |
| Cr | 2-8% |
| Mo | 1-10% |
| V | 1-6% |

and the remain is basically iron (Fe) and impurities in normal proportions. Such steel is in particular proper as hard and abrasion proved working edge for a bimetallic coater blade.

In a preferred embodiment of the method, the bimetallic doctor blade is hardened at a temperature of 1000° C. to 1250° C., preferred at a temperature of 1050° C. to 1230° C., followed by a drawing or tempering at 500° C. to 600° C.

With this thermal treatment use-hardness in the range of 53 to 68 HRc can be achieved.

Further preferred embodiments of the invention are a result from the dependent claims.

### 4. BRIEF DESCRIPTION OF THE DRAWINGS

In the following preferred embodiments are described with reference to the illustrations. In which:

FIG. 1 shows a three dimensional view of a bimetallic doctor blade according to the invention in a roll up condition;

FIG. 2 shows a three dimensional view of a partial section of a bimetallic doctor blade according to the invention at an area of the working edge;

FIG. 3 shows two schematic three dimensional macroscopic enlarged partial sections of the edge material of a doctor blade, wherein on the left side a material according to the prior art and on the right side a powder metallurgical material of the working edge is shown; and

FIG. 4 shows two macroscopic enlarged grinding surface patterns of the edge material of a doctor blade, wherein on the left side a material according to the prior art and on the right side a powder metallurgical produced material of the working edge is shown.

### DESCRIPTION OF THE PREFERRED EMBODIMENTS

In the following preferred embodiments of the present invention are described with reference to the illustrations.

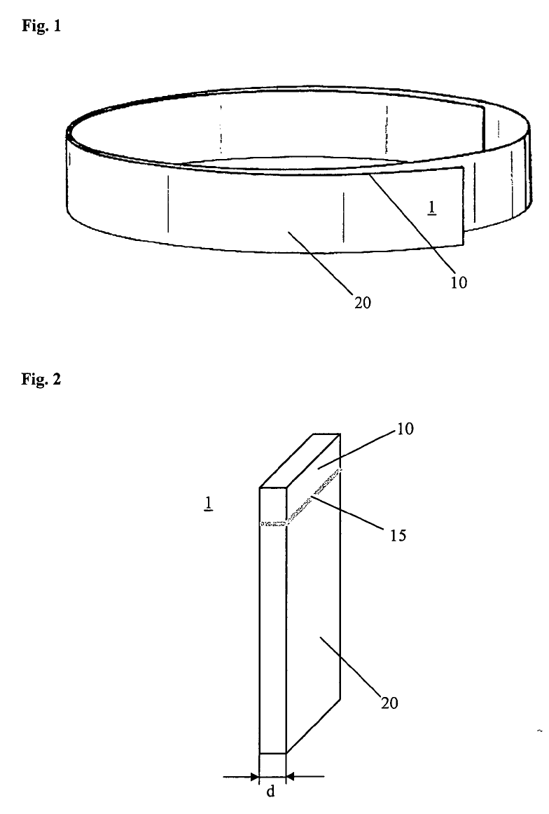

FIG. 1 shows a three dimensional view of a bimetallic doctor blade 1 according to the invention in roll up condition, like it is provided for sending. The broadness of the bimetallic doctor blade 1 is typically between 10 and 250 mm, since the thickness d of the bimetallic doctor blade 1 is between 0.065 and 1.25 mm.

For the utilization as doctor blade for pressure applications, the thickness d of the bimetallic doctor blade 1 is in the range of 0.056 to 0.25 mm. For coater blades for the paper manufacturing the thickness d is in a typical case between 0.25 and 0.64 mm and for the utilization as creping blade the bimetallic doctor blade 1 has typically a thickness d of 1.2 to 1.25 mm.

As in FIG. 2 is schematically shown, the bimetallic doctor blade has a support strip 20 made of common steel. Preferably, as steel for the support strip 20 a tool steel or spring steel is used.

The support strip consists in a preferred embodiment of tool steel with the following steel composition:

| | Percent per |
|---|---|
| Component | weight |
| C | 0.15-0.60% |
| Si | <1.5% |
| Mn | <1.5% |
| Cr | 0.5-6.5% |
| Mo | 0.5-3% |
| W | <4% |
| V | 0.03-0.75% |
| Nb | <0.15% |
| Ni | <2.0% |
| Al | <0.15% |
| Co | <4.2% |
| Zr u/o Ti u/o Ta | <0.01% |
| B | <0.001% |

wherein Mo+W/2=0.5-3% and V+Nb=0.03-0.75% respectively, and the remain is basically iron (Fe) and impurities depending on the smelting in normal proportions.

At an edge of the support strip 20 a working edge 10 is mounted, in particular welded on. Thereby, between working edge 10 and support strip 20 a compound area 15 results which usually comprises a welded joint.

The working edge 10 is made of a wire with quadratic or rectangular cross section which is connected with the support strip 20 by means of laser beam welding.

Preferably, the steel of the working edge 20 is a HSS-tool steel with the following steel composition:

| | Percent per |
|---|---|
| Component | weight |
| C | 0.9-1.7% |
| Cr | 3.8-5.0% |
| Mo | 2-6% |
| V | 2.5-6.0% |
| Co | 4.5-9.0% |

and the remain is basically iron (Fe) and impurities in normal proportions.

The wire of the working edge 10 is made of metallic powder by means of a powder metallurgical method. Therefore, an alloy for the material of the working edge 10 with the above described desired composition is initially mixed as powder. After that, the metallic powder is compressed in an almost pore-free block by means of a heat isostatic pressing. After that, this block is in heat state forged or ruled respectively to a rod and drawn to a wire.

The bimetallic doctor blade 1 is hardened preferably at an austenitic temperature of 1000° C. to 1250° C., more preferably in a temperature range of 1050° C. to 1230° C.

Thereby, the quenching is achieved between two cooling blades at a temperature of 150° C. to 250° C. Thereby, a warping of the doctor blade 1 is avoided. By means of drawing or tempering respectively of the doctor blade 1 at 500° C. to 600° C. an use hardness of the working edge of 53 to 68 HRc is achieved.

In order to avoid a further warping of the bimetallic doctor blade 1, the hardening of the working edge 10 can as well be provided by means of a laser beam whereby the straightness of the bimetallic doctor blade 1 is not affected.

Here up on, a brushing of the surface of the bimetallic doctor blade 1 follows. If desired, the bimetallic doctor blade 1 can be colored by means of drawing in an oxidizing atmosphere. After that, the bimetallic doctor blade 1 is cut to the correct length and broadness and the working edge 10 is processed by means of smoothing and/or grinding in order to obtain the desired edge pattern.

As it is shown in FIG. 2, the processed working edge 10 of the bimetallic doctor blade 1 can be straight, thus, having an angle of 90°, but depending on the desired application it can be at will beveled or rounded.

By means of the method according to the invention bimetallic doctor blades 1 with broadness up to 250 mm can be produced, without to have to forgo a sufficient straightness of the working edge 10.

For utilization as coater blade for the paper manufacturing, the working edge 10 has to have a straightness of 0.3 mm/3000 mm strip length. But also the flatness of the strip is of decisive importance. The flatness should be at least 0.3% of the nominal range according to the Pilhöjld standard.

For the utilization and doctor blade for pressure applications a straightness of 0.6 mm/3000 mm strip length has to be achieved. For the utilization as creping blade for the paper manufacturing a straightness of 1.2 mm/3000 mm strip length has to be achieved.

In addition, the bimetallic doctor blades 1 have working edges 10 which have an increased abrasion resistance in comparison with today available doctor blades.

The working edge 10 of a bimetallic doctor blade 1 according to the invention has a particularly fine structure due to the powder metallurgical manufacturing method.

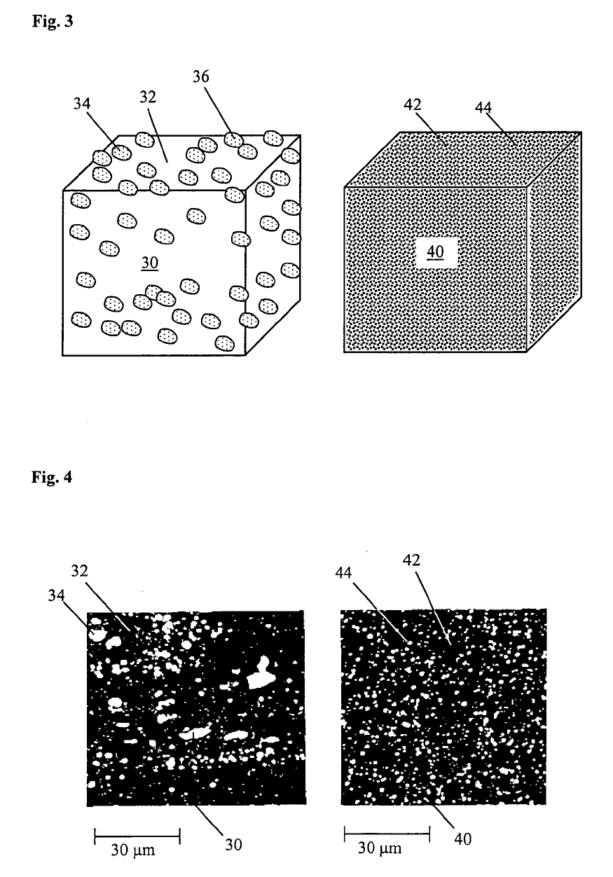

In FIGS. 3 and 4 macroscopic detailed enlargements of the structure of the working edge 10 are shown. The left sided illustration in the FIGS. 3 and 4 show a structure 30 according to the prior art which are made of a conventionally melting method. Large hard carbides 34, 36 which are embedded in a surrounding matrix alloy 32 are schematically shown. The larger carbides 34, 36 of which are shown have diameters or length of approximately 10 to 12 μm.

The distribution of the carbides 34, 36 is irregular but due to thermal processes during solidifying of the melting of the alloy 30, areas with a great number of carbide can be occur, like in FIG. 4 on the left side is shown.

After a certain period of use the working edge 10 wear out, wherein the carbides 34, 36 wear not so intensely as the surrounding matrix 32. Thereby, the carbides protrude from the surface of the remaining structure like this is shown with the carbide located at the reference sign 36. Such protruding carbides are causing grooves on the paper surface or on the counter roller or strips in the paper or in the coating of the paper so that the doctor blade has to be replaced.

On the right hand side of the FIGS. 3 and 4 a structure 40 of a working edge 10, according to the invention, is shown. The structure 40 has the same steel composition as the structure 30; however, it has been made by means of a powder metallurgical method. Thereby, finally, homogenously distributed globular carbides 44 occur which are embedded in the surrounding structure 42 (matrix). The carbides 44 which are shown in FIG. 4 on the right hand side have a diameter of only 1 to 3 μm; larger carbides do not exist due to the powder metallurgical producing method. Thus, a working edge 10 with such a structure 40 wears in a uniform manner and without protruding carbides and thus, no groove or strip forming on the paper or on the counter roll occur.

In addition, also carbides are present in the working edge 10 which have a diameter smaller as 1 μm but which cannot be shown in FIG. 4.

Furthermore, in other embodiments also due somewhat larger carbide with a diameter of 3 to 4 μm could be present in the material of the working edge (not shown on the right hand side in FIG. 4). Isolated carbides could have a diameter also somewhat larger as 4 μm. However, in order to achieve the desired characteristics of the working edge, at most three carbides with a diameter above 4 μm, preferred at most two carbides with a diameter above 4 μm and more preferred only one carbide with a diameter above 4 μm with respect to a quadratic cross section of 1000 μm² of a random metallographic grinding of a working edge 10 should be presented. Such carbides occur due to random impurities of smaller carbides and have due to its variety no noteworthy influence on regarding to the total characteristics of the edge material 10.

In the following the content of the different alloy elements of the working edge 10 and its relevancy for the particular application in a bimetallic doctor blade 1 is described in detail.

Carbon (C) should be present in the steel in sufficient quantities in order to provide a basic hardness which is sufficient that therewith the steel resists the pressure against the paper web or the roll for applying the inc respectively without that a permanent deformation occurs as well as to form MC-carbides during the tempering or drawing respectively. MC-carbides cause a deposition hardening and for this reason an improved abrasion resistance of the working edge 10. Therefore, the carbon content in percent per weight should be 0.5% to 2% C and preferably 0.9% to 1.7% C.

The chromium content (Cr) in percent per weight should be 2% to 8% Cr, preferably 3.8% to 5.0% Cr in order to give the steel a sufficient hardenability, i.e. in order to transform the steel in martensite during quenching in air or after the austenisiation. However, chromium is also a carbide builder and thus it competes with vanadium for the carbon in the steel matrix. The higher the chromium content is the lesser stable is the vanadium carbides. However, chromium carbides do not provide the deposition hardening which is desirable and which can be provided by the vanadium in the above-mentioned amount. Chromium in larger quantities occurs also a higher risk regarding to remaining austenite. Therefore, the chromium content in the steel is limited to 8%, preferably at most to 5%.

The molybdenum content (Mo) in percent per weight should be 1% to 10% Mo, preferably 2% to 6% Mo so that it can build MC-carbides together with vanadium and can positively contribute to the creation of these carbides. In the MC-carbides molybdenum is present; these dissolve easier during the austenisiation by the time when the hardening occurs and then they build a part of the MC-carbides which are built during the drawing. However, the molybdenum content must not be so high that disadvantageously amounts of molybdenum carbides are built which are instable like the chromium carbides and which grow at high temperatures. Therefore, the molybdenum content should be limited to 10%, preferably to 6%.

Molybdenum can be replaced completely or partially in a common manner by the double amount of tungsten (W). In a first preferred embodiment the alloy composition of the working edge 10 should not content tungsten which exceeds above an impurity level.

Vanadium (V) should be present in the steel in order to build very small MC-carbides during the tempering or drawing respectively by deposition. It is understood that these MC-carbides are the main reason for the surprising good abrasion resistance of a bimetallic doctor blade according to the invention. The carbides have a submicroscopic dimension what means a maximum dimension in the size between 1 and 3 μm. In order to provide a sufficient high vanadium rate of MC-carbides, the vanadium content in percent per weight should be 1% V to 6% V, preferably 2.5% to 6% V.

Cobalt (Co) can be present in the steel in percent per weight between 1% to 12% Co, preferably 4.5% to 9% Co. Cobalt improves the temperature resistant of the steel. However, cobalt makes the steel more brittle and increases the deformation hardening during possible cool forming processes.

For the rest, the steel contains basically nothing else as iron (Fe). Further elements, including for example aluminum nitrogen, carbon, titanium, niobium, sulphate and phosphor are only present in the steel as impurities or as unavoidable sub elements which also occur during the producing of metallic powders.

1. Bimetallic doctor blade (1) comprising:
a) a support strip (20) composed of a conventionally produced steel; and
b) a working edge (10) composed of a steel characterized in that
c) the working edge (10) is produced of a powder metallurgical method and of a wire which is produced metallurgical and which is welded on the support strip (20).

2. Bimetallic doctor blade according to claim 1, wherein the working edge (10) is produced of steel with a steel composition comprising in percent by weight

| Component | Percent per weight |
|---|---|
| C | 0.5-2.0% |
| Cr | 2-8% |
| Mo | 1-10% |
| V | 1-6% |

and the remain is basically iron (Fe) and impurities in normal proportions.

3. Bimetallic doctor blade according to claim 2, wherein the steel of the working edge (10) furthermore comprises 1 to 12 percent per weight Co.

4. Bimetallic doctor blade according to claim 3, wherein the steel of the working edge (10) comprises the following steel composition:

| Component | Percent per weigth |
|---|---|
| C | 0.9-1.7% |
| Cr | 3.8-5.0% |
| Mo | 2-6% |
| V | 2.5-6.0% |
| Co | 4.5-9.0% |

5. Bimetallic doctor blade according to claim 1, wherein the working edge (10) comprises carbides and basically all carbides of the working edge (10) have a diameter which is smaller than 4 μm, preferably smaller as 3 μm.

6. Bimetallic doctor blade according to claim 1, wherein the working edge (10) has a hardness of 53 to 68 HRc.

7. Bimetallic doctor blade according to claim 1, wherein the wire is a flat wire with a quadratic or rectangular cross section before it is welded.

8. Bimetallic doctor blade according to claim 1, wherein the wire is welded on the support strip by means of a laser beam.

9. Bimetallic doctor blade according to claim 1, wherein the wire is made of a block which is made by means of a hot isostatic pressing of a metal powder.

10. Bimetallic doctor blade according to claim 1, wherein the support strip has the following steel composition:

| Component | Percent per weight |
|---|---|
| C | 0.15-0.60% |
| Si | <1.5% |
| Mn | <1.5% |
| Cr | 0.5-6.5% |
| Mo | 0.5-3% |
| W | <4% |
| V | 0.03-0.75% |
| Nb | <0.15% |
| Ni | <2.0% |
| Al | <0.15% |
| Co | <4.2% |
| Zr u/o Ti u/o Ta | <0.01% |
| B | <0.001% |

wherein Mo+W/2=0.5-3% and V+Nb=0.03 to 0.75% and the remain is basically iron (Fe) and melting impurities in normal proportions.

11. Bimetallic doctor blade according to claim 1, having a broadness of 10 to 250 mm and a thickness of 0.065 to 1.25 mm, in particular
a) a thickness of 0.065 to 0.203 mm for utilisation as doctor blade for pressure applications; or
b) a thickness of 0.25 to 0.64 mm for the utilisation as coater blade for paper production; or
c) a thickness of 1.2 to 1.25 mm for utilisation as creping blade for paper production.

12. Method for manufacturing a bimetallic doctor blade (1) characterized by the following steps:
a) Producing of a flat wire from a metal powder by means of a powder metallurgical producing method;
b) welding the flat wire on a conventionally produced support strip (20) made of steel in order to build a bimetallic doctor blade (1) with support strip (20) and working edge (10).

13. Method according to claim 12, wherein the flat wire comprises the following steel composition:

| Component | Percent per weight |
|---|---|
| C | 0.5-2.0% |
| Cr | 2-8% |
| Mo | 1-10% |
| V | 1-6% |

and the remain is basically iron (Fe) and impurities in normal proportions.

14. Method according to claim 12, further comprising the following steps:
c) hardening the bimetallic doctor blade (1) at a temperature of 1000° Celsius to 1250° Celsius, preferably at a temperature of 1050° Celsius to 1230° Celsius; and
d) drawing or tempering the bimetallic doctor blade (1) at a temperature of 500° C. to 600° C.
